(19) United States
(12) Patent Application Publication
(10) Pub. No.: US 2024/0262422 A1
(43) Pub. Date: Aug. 8, 2024

(54) SKATEBOARD CHASSIS ASSEMBLY FOR AN ELECTRIC VEHICLE

(71) Applicants: Venugopal GARIMELLA, Troy, MI (US); Charles KANEB, Shelby Township, MI (US); Ketan CHOUDHARI, Troy, MI (US); MAGNA INTERNATIONAL INC., Aurora (CA)

(72) Inventors: Venugopal GARIMELLA, Troy, MI (US); Charles KANEB, Shelby Township, MI (US); Ketan CHOUDHARI, Troy, MI (US)

(21) Appl. No.: 18/562,873

(22) PCT Filed: May 25, 2022
(86) PCT No.: PCT/US2022/030815

§ 371 Date: Nov. 21, 2023

Related U.S. Application Data
(60) Provisional application No. 63/193,443, filed on May 26, 2021.

(51) Int. Cl. B62D 21/02; B60K 1/04; B60K 7/00; B60R 19/02; B62D 21/11; B62D 63/02

(52) U.S. Cl. CPC B62D 21/02; B60K 1/04; B60K 7/0007; B60R 19/023; B62D 21/11; B60K 2001/0438; B62D 63/025

(57) ABSTRACT

A skateboard chassis assembly for an electric vehicle includes a frame extending from a front end to a rear end and including a central portion defining a central pocket. A front bumper is connected to the front end and a rear bumper is connected to the rear end. A battery housing is at least partially located in the central pocket. The central portion of the frame includes a pair of central longitudinal members extending in spaced relationship with one another and at least one central cross member extending transversely between the pair of central longitudinal members to establish a structural load path for the electric vehicle, and enable the elimination of redundant features from a corresponding body-in-white structure.

### CROSS-REFERENCE TO RELATED APPLICATION

This PCT International Patent application claims the benefit of U.S. Provisional Patent Application Ser. No. 63/193,443 filed on May 26, 2021, the entire disclosure of which is hereby incorporated by reference.

### BACKGROUND OF THE INVENTION

### 1. Field of the Invention

The present invention relates an underbody for an electric vehicle. More particularly, the present invention relates to a skateboard chassis assembly arranged as an underbody for an electric vehicle.

### 2. Related Art

This section provides background information related to the present disclosure which is not necessarily prior art.

Automobiles are the subject of a continuing effort to reduce weight and increase fuel efficiency without detracting from performance. This desire to increase fuel efficiency is both economically and environmentally motivated and has advanced internal components in automobiles as evidenced by developments in batteries, particularly in electrified automobiles. Electrified automobiles include a range of technologies that rely on electric energy to propel an automobile. Some electrified automobiles still rely predominantly on fossil fuels and use electricity as a supportive energy to improve fuel efficiency. Other electrified automobiles rely predominantly or entirely on electricity for propulsion of the automobile. In either arrangement, while electric energy is a more economically and environmentally favorable technology than relying completely on fossil fuels, batteries are heavy, expensive, and relatively fragile compared to neighboring mechanical components. As such, the packaging of batteries, particularly within an electrified vehicle, requires a number of design considerations including weight distribution, temperature regulation, and serviceability. In terms of serviceability, there is a growing need particularly for electrified automobiles in which the batteries are located in an accessible configuration. In terms of packaging and weight distribution, the prior art skateboard assemblies are not functionally integrated (less parts consolidation), they are not space efficient, have high part count, and lead to structural redundancies with the body-in-white.

To meet the above minimum requirements, batteries have traditionally been packaged in protective housings that are constructed entirely independent from a frame of the automobile. As the automotive industry continues to trend towards primarily battery powered solutions, skateboard chassis systems have become more and more popular. Skateboard chassis systems or assemblies typically include the battery housing, a suspension system, a brake system, and a propulsion system. Because many skateboard chassis assemblies include a majority of driving and electric components necessary to operate an automobile, they can be up-scaled for a variety of vehicle bodies. While the development of skateboard chassis systems have improved certain aspects of vehicular architecture, there are still notable shortcomings. For example, there are a number of redundant structures between the skateboard chassis system and body-in-white. In addition, the battery housing provides weight and space without providing any structural functionality beyond carrying battery modules. Moreover, these traditional battery housings can be difficult to connect to a frame of the skateboard chassis, and create weak points in the frame.

Accordingly, there is a continuing desire to further develop and refine skateboard chassis system construction and operation such that they are not subjected to traditional drawbacks such as structural redundancies and inefficiencies.

### SUMMARY OF THE INVENTION

According to one aspect of the disclosure, a skateboard chassis assembly for an electric vehicle includes a frame extending from a front end to a rear end and including a central portion defining a central pocket. A front bumper is connected to the front end and a rear bumper is connected to the rear end. A battery housing is at least partially located in the central pocket. The central portion of the frame includes a pair of central longitudinal members extending in spaced relationship with one another and at least one central cross member extending transversely between the pair of central longitudinal members to establish a structural load path for the electric vehicle, and enable the elimination of redundant features from a corresponding body-in-white structure for the electric vehicle. For example, the front and rear bumpers of the skateboard chassis assembly allows these bumper components to be eliminated from the body-in-white. Further, the pair of central longitudinal members allows the elimination of side sills from the body-in-white. Additionally, the battery housing provides an integrated battery pack for the skateboard chassis assembly.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a top view of a skateboard chassis assembly in accordance with an aspect of the present disclosure;

FIG. 2 is a bottom view of the skateboard chassis assembly illustrated in FIG. 1;

FIG. 3 is a side view of the skateboard chassis assembly illustrated in FIG. 1;

FIG. 4 is a front view of the skateboard chassis assembly illustrated in FIG. 1;

FIG. 5 is an exploded view of the skateboard chassis assembly of FIG. 1 for connection with a body-in-white;

FIG. 6 is a perspective view of the skateboard chassis assembly in accordance with another aspect of the present disclosure;

FIG. 7 is a top view of the skateboard chassis assembly illustrated in FIG. 6;

FIG. 8 is a bottom view of the skateboard chassis assembly illustrated in FIG. 6;

FIG. 9 is a side view of the skateboard chassis assembly illustrated in FIG. 6;

FIG. 10 is a front view of the skateboard chassis assembly illustrated in FIG. 6;

FIG. 11 is an exploded view of the skateboard chassis assembly illustrated in FIG. 6;

FIG. 12 illustrates a small overlap rigid barrier configuration of the skateboard chassis assembly for enabling absorption strategies during a crash event in accordance with an aspect of the present disclosure;

FIG. 13 illustrates the skateboard chassis assembly immediately after a crash event in accordance with an aspect of the present disclosure;

FIG. 14A illustrates the skateboard chassis assembly including a suspension system that is incorporated into the absorption strategy during a crash event in accordance with an aspect of the present disclosure;

FIG. 14B illustrates the skateboard chassis assembly and the suspension system during a crash event in accordance with an aspect of the present disclosure;

FIG. 15 is a schematic view of a propulsion system of the skateboard chassis assembly in accordance with an aspect of the present disclosure;

FIG. 16 is a cross-sectional view illustrating a connection strategy between the skateboard chassis assembly and the body-in-white in accordance with an aspect of the present disclosure; and

FIG. 17 is a cross-sectional view illustrating a connection strategy between the skateboard chassis assembly and the body-in-white in accordance with another aspect of the present disclosure.

### DETAILED DESCRIPTION OF THE ENABLING EMBODIMENTS

Example embodiments will now be described more fully with reference to the accompanying drawings. In general, the subject embodiments are directed to a skateboard chassis assembly for an electric vehicle. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, a skateboard chassis assembly 10 for an electric vehicle is generally illustrated, and as will be explained in more detail below, provides a skateboard architecture that reduces redundant features by incorporating body-in-white components into the skateboard chassis assembly 10, maximizes commodity consolidation, provides a frame 12 that forms a part of the structural load path, and can be up-scaled and customized for a variety of end uses. The skateboard chassis assembly 10 also provides a structural, modular and scalable platform that can be used in an electrified or semi-electrified automobile, such as a car, pick-up truck, SUV, semi-truck or other automobiles.

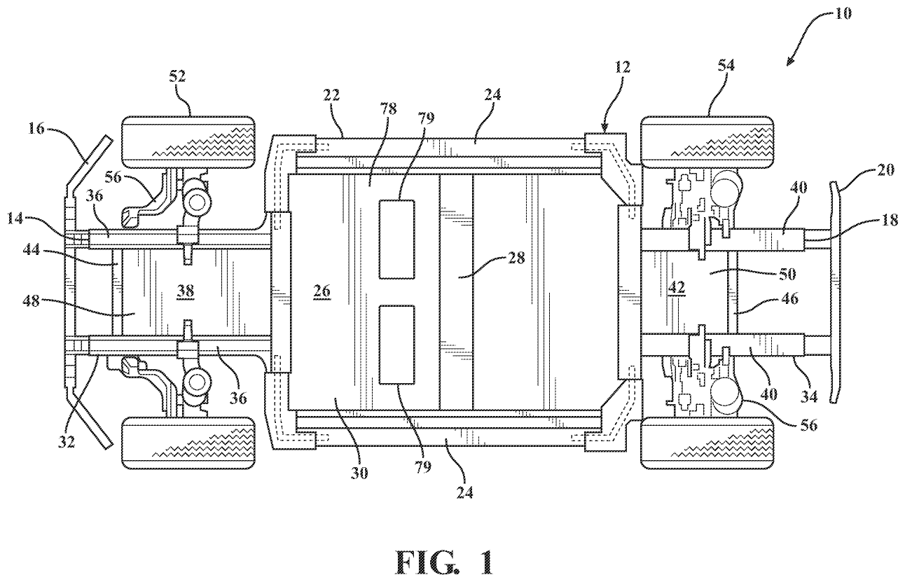

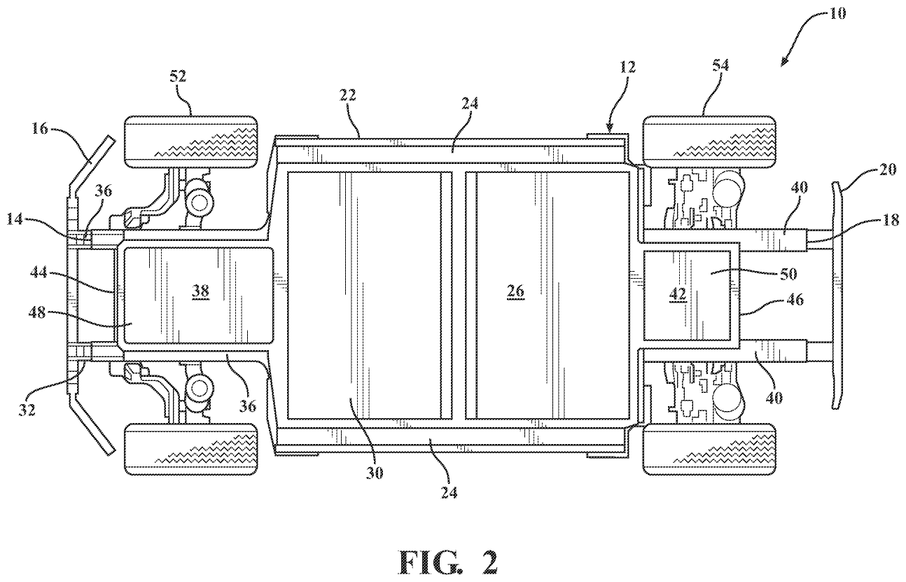

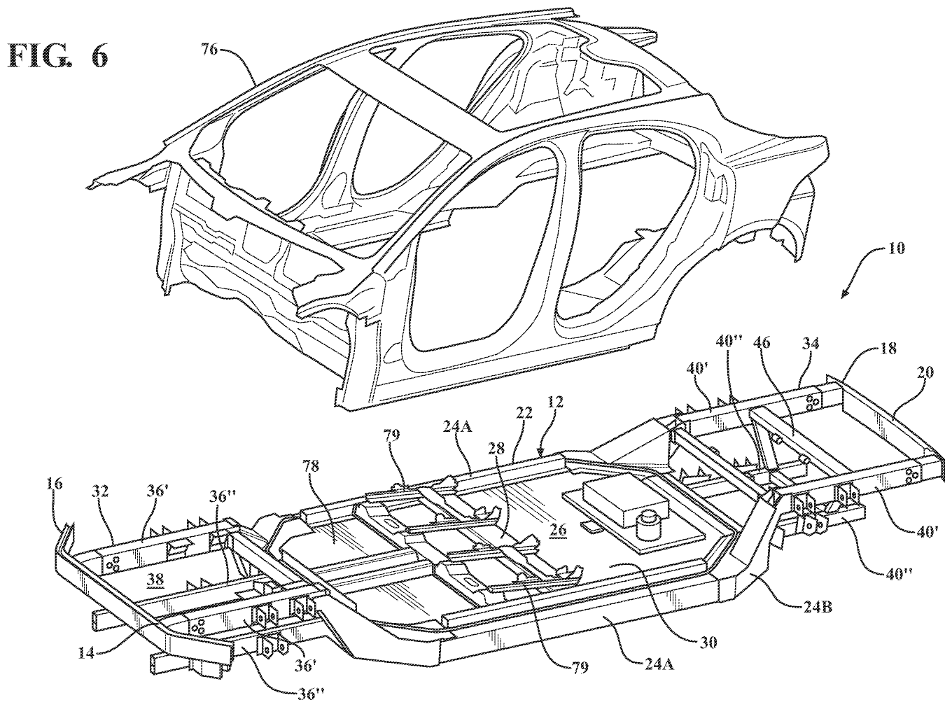

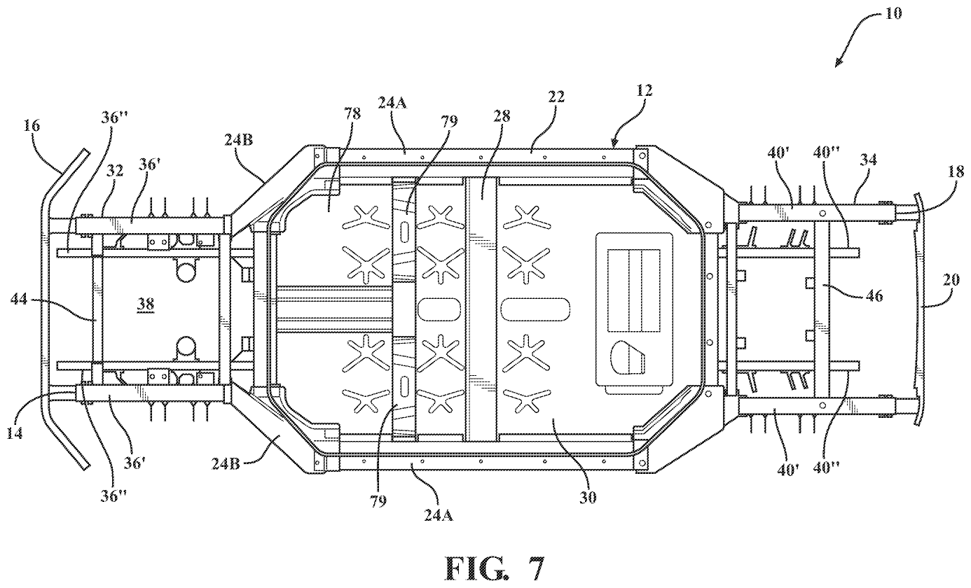

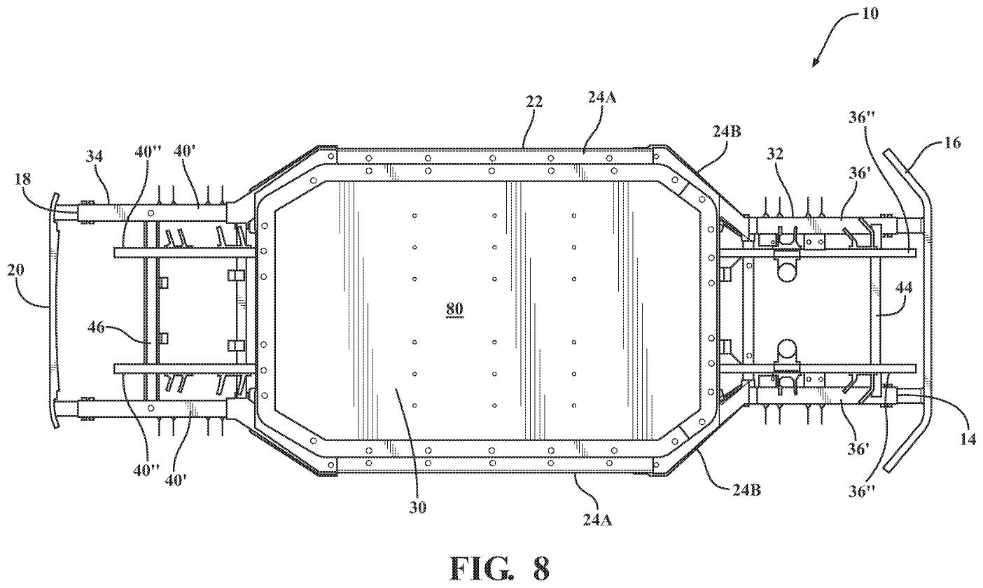

As best illustrated in FIGS. 1-2 and 5-8, the skateboard chassis assembly 10 includes a frame 12 that extends between a front end 14 connected to a front bumper 16 and a rear end 18 connected to a rear bumper 20. Put another way, the front and rear bumpers 16, 20 are mounted on and incorporated into the skateboard chassis assembly 10 in contradistinction to prior art skateboard chassis assemblies. The frame 12 includes a central portion 22 having a pair of central longitudinal members 24 extending in spaced and generally parallel relationship with one another to define a central pocket 26. The central longitudinal members 24 are configured to replace side sills of a traditional vehicle frame/body-in-white and thus form a part of the structural load path of the electrified automobile. The central skateboard portion 22 of the frame 12 includes at least one central cross-member 28 that extends between the longitudinal members 24 for providing additional structure along the load path in the cross-car direction. As illustrated in FIG. 6, in an embodiment, the central longitudinal members 24 may include parallel sections 24A and angular or transverse sections 24B. A central battery housing 30 is disposed within the central pocket 26 and houses a plurality of battery modules 31 for the electrified or semi-electrified vehicle. In some embodiments, the battery modules 31 include tab-less batteries, dry electrode, or new electrode (solid state battery). The battery modules 31 may include an anode of Silicon and/or Graphite and a cathode of Nickel. The battery modules 31 alternatively include an electrolyte including a solid state battery configurations with Sliver-Carbon instead of Lithium. The anode and cathode chemistry may further boost the range of the vehicle in addition to the allowance of increase battery module carrying capacity.

As further illustrated in FIGS. 1-2 and 5-8, the frame 12 of the skateboard chassis assembly 10 additionally includes a front portion 32 that extends between the central portion 22 and the front bumper 16 and a rear portion 34 that extends between the central portion 22 and the rear bumper 20. The front skateboard portion 32 of the frame 12 includes at least one pair of front longitudinal members 36 extending between the central portion 22 and the front bumper 16 in spaced and generally parallel relationship with one another to define a front pocket 38, and the rear portion 34 includes at least one pair of rear longitudinal members 40 extending between the central portion 22 and the rear bumper 20 in spaced and generally parallel relationship with one another to define a rear pocket 42. The at least one pair of front longitudinal members 36 preferably includes a pair of front top longitudinal members 36′ and a pair of front bottom longitudinal members 36″. Similarly, the at least one pair of rear longitudinal members 40 preferably includes preferably includes a pair of rear top longitudinal members 40′ and a pair of rear bottom longitudinal members 40″. The pairs of front and rear longitudinal members 36′, 36″, 40′, 40″ are configured to replace and eliminate the rail, shotgun and shock tower of a traditional vehicle frame, and thus further reduces redundancy between the skateboard chassis assembly 10 and a body-in-white 76 for the vehicle. The front portion 32 of the frame 12 can also include at least one front cross member 44 extending transversely between the at least one pair of front longitudinal members 36, and the rear portion 34 of the frame 12 can also include at least one rear cross member 46 extending transversely between the at least one pair of rear longitudinal members 40. Thus, as will be described in greater detail below, the front and rear portions 32, 34 of the frame 12 also contribute to providing a structural load path for the skateboard chassis assembly 10, and enable a small overlap rigid barrier (SORB) strategy for the skateboard chassis assembly 10.

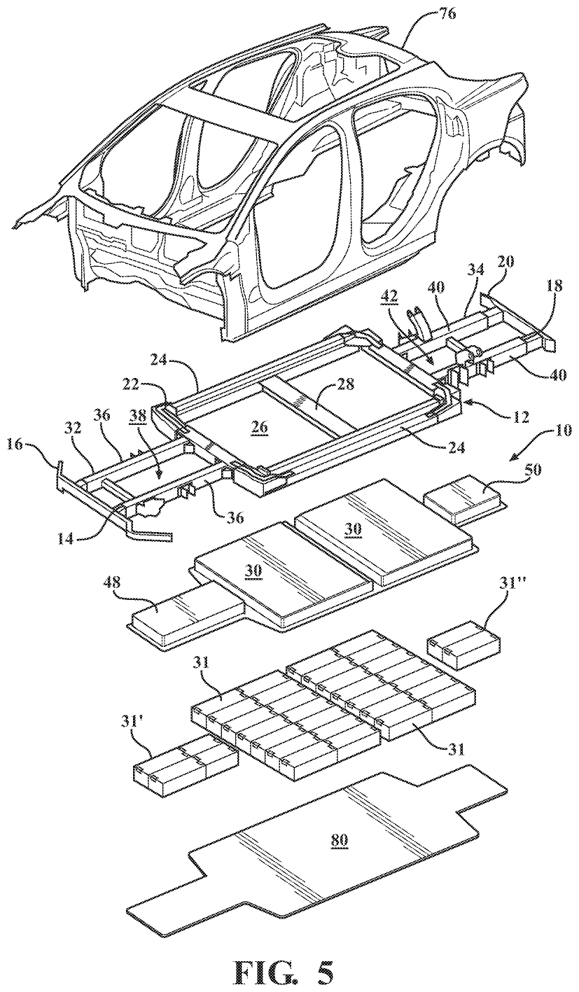

As further illustrated in FIGS. 1-2 and 5, in accordance with an aspect of the disclosure, a front battery housing 48 having additional front battery modules 31′ can be disposed in the front pocket 38 and a rear battery housing 50 having additional rear battery modules 31″ can disposed in the rear pocket 42. Thus, an overall battery housing for the skateboard chassis assembly 10 (comprised of the combined portions of the central battery housing 30, front battery housing 48 and the rear battery housing 50) extends between the front pocket 38, the central pocket 26 and the rear pocket 42 such that at least one battery module 31 is located in the central pocket 26, at least one battery module 31′ is located in the front pocket 38, and at least one battery module 31″ is located in the rear pocket 42 (FIG. 5). Therefore, instead of limiting the carrying capacity to the central pocket 26, in accordance with this aspect, the front and rear pockets 38, 42 can provide additional battery storage space, and thus increase battery carrying space of the skateboard chassis assembly 10 relative to the prior art designs. Thus, the front and rear longitudinal members 36, 40 are integrated with the skateboard chassis assembly 10 to allow for additional space for incorporating battery modules.

More specifically, traditional skateboard assemblies typically include a front and rear cradle instead of the front and rear portions 32, 34 of the subject skateboard chassis assembly 10. The front and rear cradles connect portions of a traditional suspension assembly and portions of a traditional propulsion system without providing any additional battery storage and requiring significant investments in space. More particularly, the traditional suspension systems connect to the front and rear cradles with shock towers that require large vertical packaging requirements and motor mounts that require propulsion system components to be located in a location of the front pocket 38 and/or the rear pocket 42 eliminating space that the present assembly can utilize to carry additional battery modules 31′, 31″ in the front and rear battery housings 48, 50. However, as illustrated in FIGS. 6-8 and 11, in accordance with another aspect, the battery housing 30 can be located entirely within the central pocket 26 without departing from the scope of the subject disclosure.

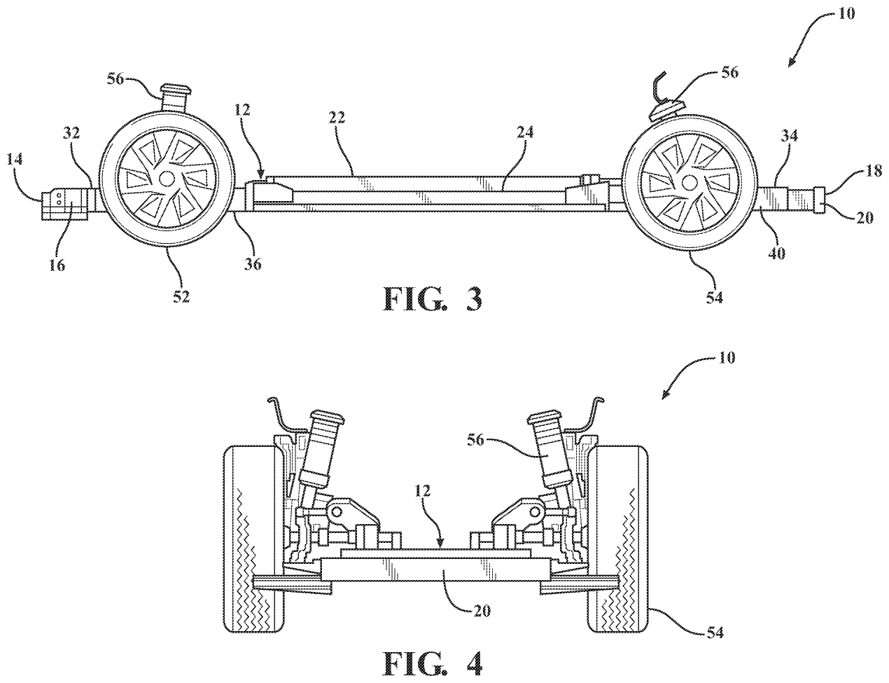

As best illustrated in FIGS. 1-4, a pair of front wheels 52 are connected to and/or supported by the front portion 32 of the frame 12 and a pair of rear wheels 54 are connected to and/or supported by the rear portion 34 of the frame 12. More specifically, a suspension assembly 56 is connected to the front and rear longitudinal members 36, 40 of the front and rear portions 32, 34 of the frame 12 to establish the interconnection between the wheels 52, 54 and the frame 12 and provide a scalable, compact and common suspension architecture for the skateboard chassis assembly. In some embodiments, the suspension assembly 56 may include a hydrolastic or hydragas configuration. Benefits of these configurations include compact designs requiring very little installation space for integration into the skateboard chassis assembly 10, eliminating the previous packaging requirements of the shock towers and suspension strut attachments. Thus, in some embodiments, the front and rear components of the suspension assembly 56 may include fluid-filled hydrolastic displacers units having a rubber spring. The damping functionality may therefore be achieved by the displaced fluid passing through a rubber valve. In some embodiments, the suspension assembly 56 may include a hydragas unit. Hydragas provides an evolution of traditional hydro-pneumatic suspension in which a rubber spring is replaced by a separating diaphragm with nitrogen gas. In some embodiments, hydraulic fluid running between front to the rear units of the suspension assembly 56 is pre-pressurized such that the nitrogen section provides both the spring and damping functionality.

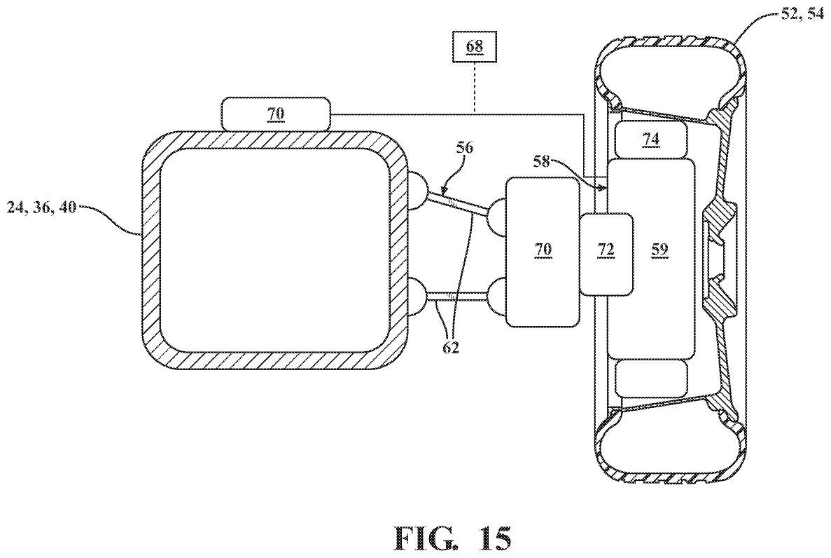

As best illustrated in FIG. 15, a propulsion assembly 58 may be connected to and/or supported by the front portion 32 of the frame 12, a rear portion 34 of the frame 12, or a combination thereof. In an embodiment, the propulsion assembly 58 includes an in-wheel motor 59 located in or adjacent to at least one of the front or rear wheels 52, 54. In some embodiments, the in-wheel motor 59 (e.g., a motor and inverter E-Drive mount) is located in or adjacent to each of the front and rear wheels 52, 54 for 4WD/AWD functionality. However, although the propulsion assembly 58 is illustrated as an in-wheel motor 59, the skateboard chassis assembly 10 is designed to accommodate other propulsion systems, such as conventional motors, driving and steering mechanisms, without departing from the scope of the subject disclosure.

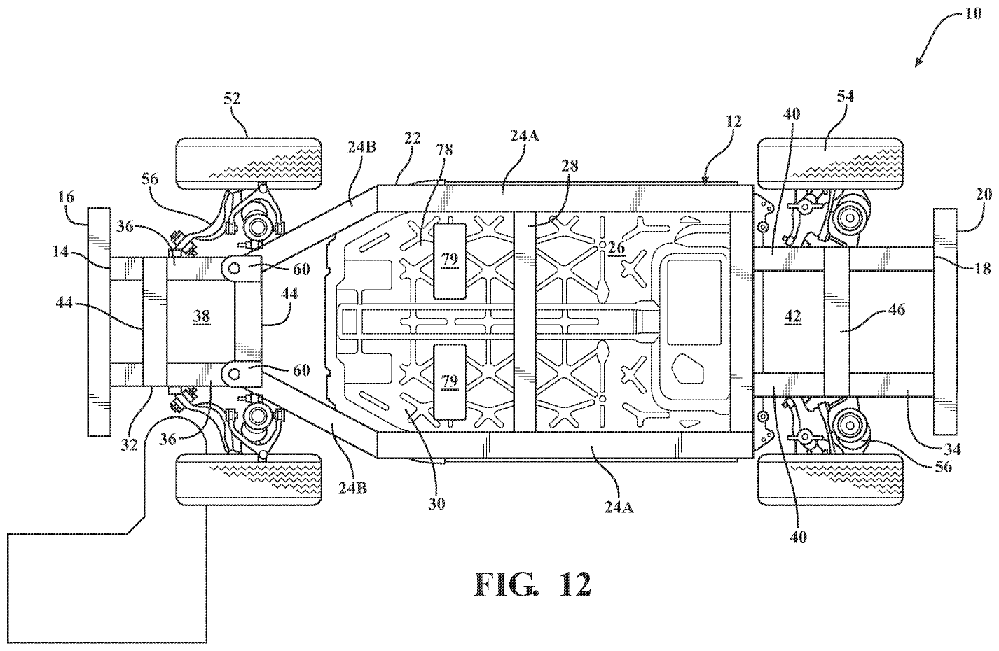

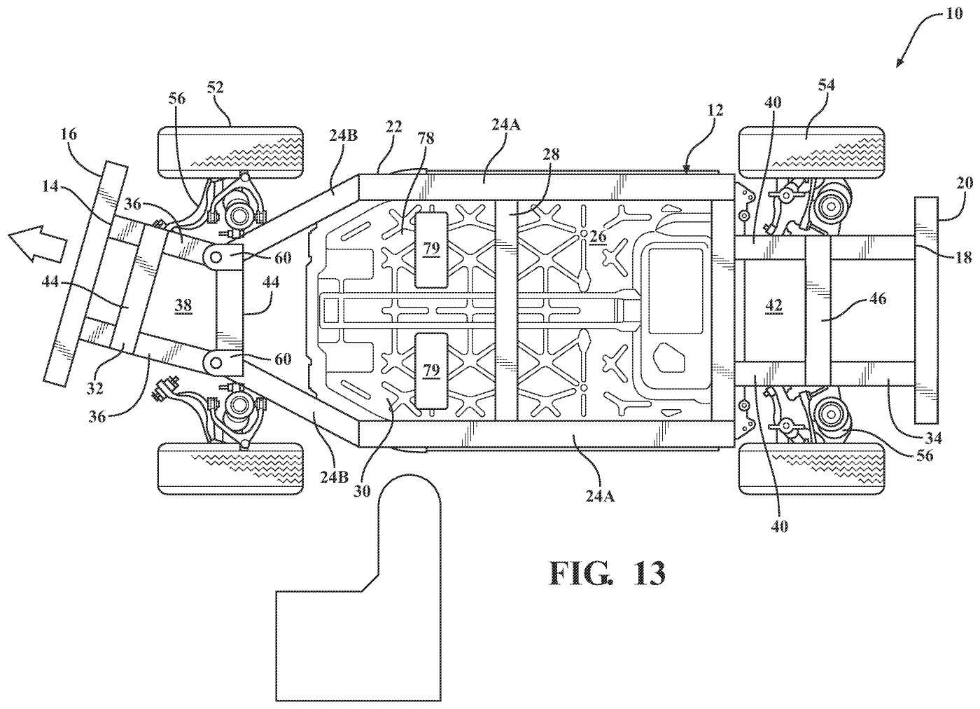

As best illustrated in FIGS. 12-13, the front portion 32 of the frame 12 is interconnected to the central portion 22 of the frame via a pivotable connection 60 that includes a hard bushing with a pivot mechanism. Therefore, during a crash event involving a side portion of the front bumper 16 (FIG. 11), the front portion 32 of the frame 12 is displaced (FIG. 12), thus changing the traveling direction of the skateboard chassis assembly 10 and deflecting the front battery housing 48 from direct impact and also reducing structural intrusions. The front bumper 16 may be actively integrated with the pivotable connection 60 via an ECU.

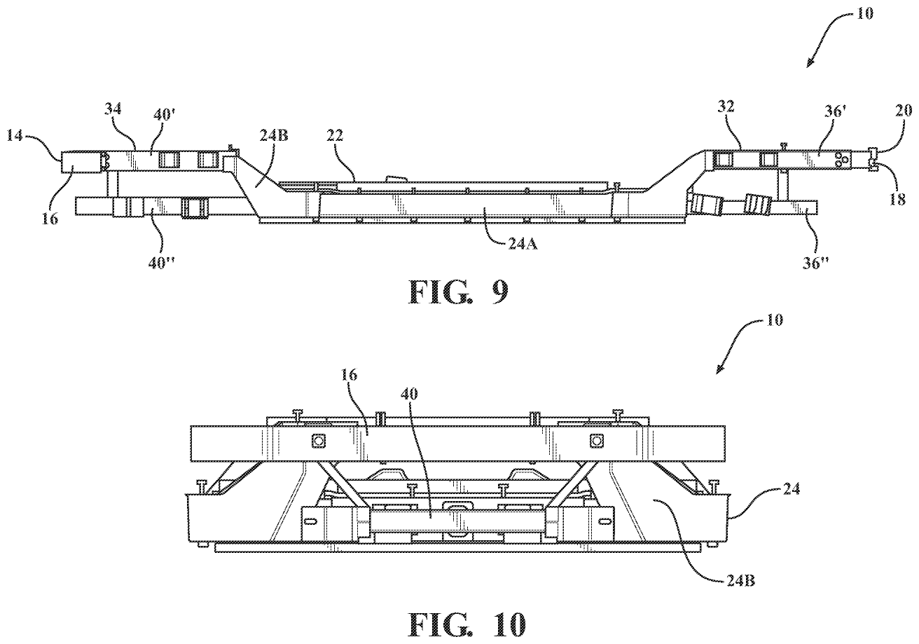

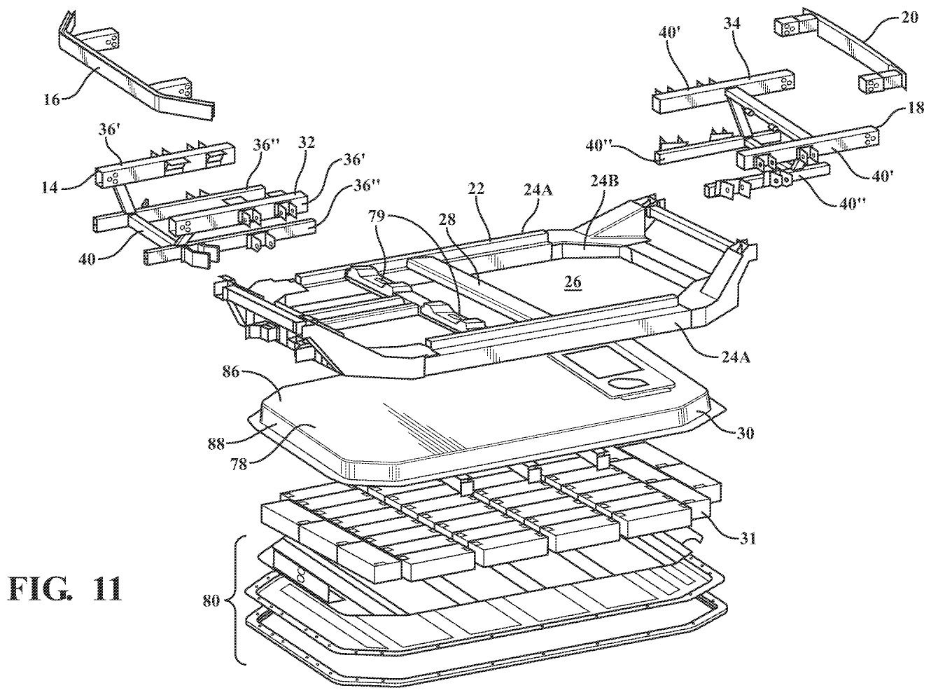

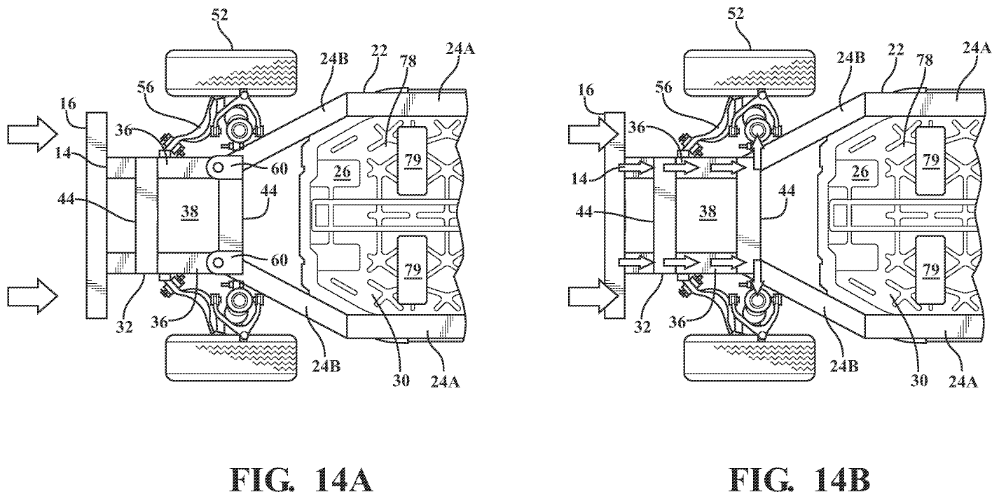

As illustrated in FIGS. 14A-14B, the suspension assembly 56 may provide further reaction strategies during a frontal crash event. In some embodiments, during a frontal crash event, (NCAP, full overlap) the front bumper 16 response can actively integrate with the suspension assembly 56 to generate a reaction strategy depending on bumpers deformation mode. For example, a reading of a collision or anticipated collision by the ECU integration with the front bumper 16 may extend a structure (e.g., the front bumper 16 or suspension system 56) from the front of the car, shifting the length or weight distribution over which the collision takes place. As illustrated in FIG. 9B, a direct impact applied to the front bumper 16 is illustrated wherein the structural load path travels from the front bumper 16 along the front portion 32 of the frame 12 and to the suspension assembly 56. In FIG. 9B, the front units of the suspension assembly 58 are illustrated as reacting to an impact with the front bumper 16.

As best illustrated in FIG. 15, the suspension assembly 56 can alternatively include a double wish-bone 62 with integral links connected to the front and/or rear portions 32, 34 of the frame 12. A steering system including wireless steering (steer-by-wire) modules can be utilized to eliminate the tie-rod requirements of the prior art designs, with the steering system connected to the front and/or rear wheels 52, 54. A lowered suspension assembly 56 is facilitated by the double wishbone structure 62 provides a reduced rollover risk, better handling with a lower center of gravity, and improved aerodynamics. Use of the in-wheel motors as the propulsion assembly 58 in conjunction with the wireless steering unit provides a minimal steering radius, a compact design, and facilitates certain impact reaction strategies.

As further illustrated in FIG. 15, the propulsion assembly 58 may include a propulsion control unit 68 for controlling certain settings of the in-wheel motors and includes inverters 70 located between the battery modules and the in-wheel motors. The steering system and the propulsion control unit 68 may be in wired or wireless connection with a drive module that permits manual driving, autonomous driving, or a combination thereof. This configuration includes a reduction in parts permitting a reduced design space, an increased range (no mechanical transmission required as wheels are propelled directly, with steer-by-wire enabling further structural space efficiency), and a lower center of gravity (reduced un-sprung mass). The propulsion assembly 58 may further include a steering gear 70 and a gear box 72 in operable connection with the in-wheel motor. A braking system 74 may further be incorporated and controlled electronically (e.g., wirelessly).

As best illustrated in FIG. 5, the skateboard chassis assembly 10 is intended for connection to a body-in-white 76. An upper surface 78 of the central battery housing 30 may define a floor of the electric vehicle that has traditionally been an independent structure incorporated into the body-in-white. Thus, as best illustrated in FIG. 1, in an arrangement the upper surface 78 of the central battery housing 30 can define a seat attachment 79 located directly on the skateboard chassis assembly 10. Alternatively, as best illustrated in FIG. 6, the central cross member 28 of the frame 12 can define the seat attachment 79 located directly on the skateboard chassis assembly 10. In either arrangement, the skateboard chassis assembly 10 provides the floor for the electric vehicle, thus eliminating the floor from the body-in-white 76 (See FIG. 6), as would otherwise be present in a traditional body-in-white structure. As further illustrated in the Figures, a carrier tray 80 extends underneath the plurality of battery modules 31, 31′, 31″ and holds the battery modules 31, 31′, 31″ within the front, central and rear portions of the battery housings 30, 48, 50 from underneath the skateboard chassis assembly 10.

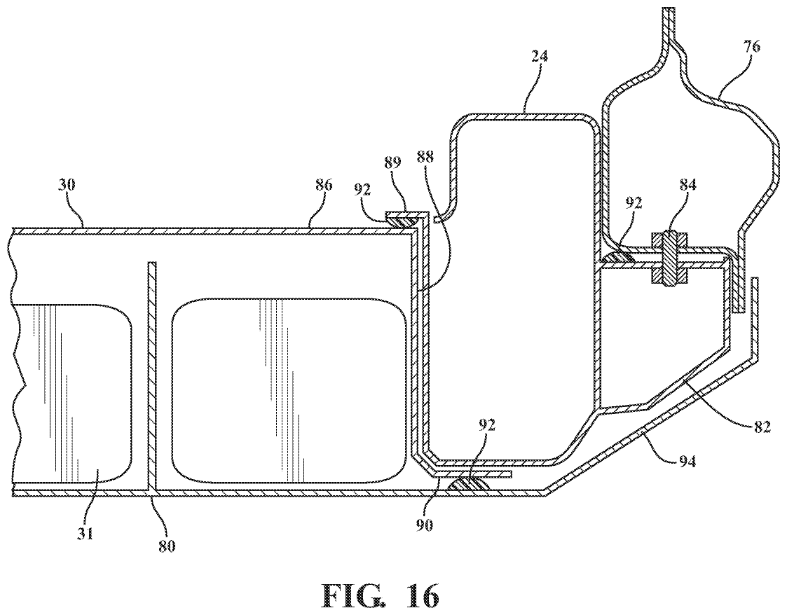

As illustrated in FIG. 16, the central longitudinal members 24 may each include a multi-celled design including an outer shoulder 82 for connection to the body-in-white 76. The connection between the central longitudinal members 24 and the body-in-white 76 may be via mechanical fasteners 84. However, the longitudinal members 24 of the frame 12 could also be secured to the body-in-white 76 via other means, such via at least one weld, sealing with bolts, adhesive with bolts, or isolators with bolts, without departing from the scope of the subject disclosure. The central battery housing 30 may include a cover 86 and sidewall portions 88. The cover 86 may connect to a longitudinal tab 89 on the central longitudinal members 24 on a first upper portion and the sidewall 88 may define a sidewall tab 90 connected to the central longitudinal members 24 on a second lower portion. A seal 92 may be located between the cover 86 and the longitudinal tab 88, between the cover tab 90 and the longitudinal member 24, between the carrier tray 80 and the central battery housing 30, and between the longitudinal member 24 (e.g., outer shoulder 82) and the body-in-white 76. A styling cover 94 may extend between the body-in-white 76 and the carrier tray 80.

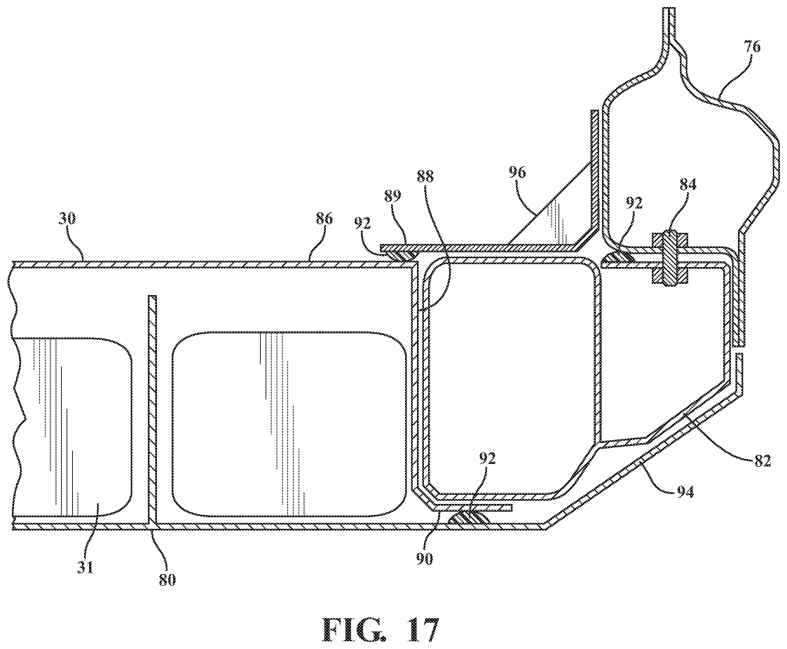

FIG. 17 illustrates an alternative arrangement wherein the longitudinal members 24 include an upper bracket 96 that forms part of the outer shoulder 82 and the longitudinal tab 88. The outer shoulder 82 may extend around the central longitudinal members 24, and the at least one central cross member 28, or a combination thereof such that the outer shoulder 82 forms a complete loop and the body-in-white 76 is completely sealed around an underside thereof.

As will be appreciated in view of the aforementioned disclosure, the skateboard chassis assembly 10 provides a scalable design via interchanging various sizes of the front and rear portions 32, 34 of the frame 12. In addition, the skateboard chassis assembly 10 may be highly modular and interchanging the front and rear portions 32, 34 may provide various types of propulsion systems, suspension systems, and steering systems. Thus, the skateboard chassis assembly 10 is a structural, modular and scalable platform. Additionally, as best illustrated in FIGS. 5 and 6, the skateboard chassis assembly 10 facilitates use of a top hat body-in-white 76 that is minimalistic, without an underbody, front and rear end rails. The skateboard chassis assembly 10 provides a space efficient design that has potential to increase the battery capacity/range, lead to fewer parts with lower production costs.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A skateboard chassis assembly for an electric vehicle, comprising:
a frame extending from a front end to a rear end and including a central portion defining a central pocket;
a front bumper connected to said front end and a rear bumper connected to said rear end for eliminating the front and rear bumper components from a body-in-white for the electric vehicle;
a battery housing at least partially located in said central pocket for incorporating a battery pack into the skateboard chassis assembly;
said central portion of said frame including a pair of central longitudinal members extending in spaced relationship with one another and at least one central cross member extending transversely between said pair of central longitudinal members to establish a structural load path for the electric vehicle.

2. The skateboard chassis assembly as set forth in claim 1, wherein said frame including a front portion having at least one pair of front longitudinal members extending in spaced relationship with one another between said central portion and said front bumper and a rear portion having at least one pair of rear longitudinal members extending in spaced relationship with one another between said central portion and said rear bumper for eliminating the front and rear rails and shotguns from the body-in-white.

3. The skateboard chassis assembly as set forth in claim 2, wherein said front portion of said frame defines a front pocket and said rear portion of said frame defines a rear pocket and said battery housing is at least partially located in said front pocket or said rear pocket.

4. The skateboard chassis assembly as set forth in claim 3, wherein said battery housing is located in said front pocket, said central pocket and said rear pocket.

5. The skateboard chassis assembly as set forth in claim 2, wherein said front portion of said frame includes at least one front cross member extending between said pair of front longitudinal members and said rear portion of said frame includes at least one rear cross member extending between said rear longitudinal members.

6. The skateboard assembly as set forth in claim 2, further comprising a suspension assembly connected to said pair of front longitudinal members and said pair of rear longitudinal members for interconnected said frame of the skateboard chassis assembly to a pair of front wheels and a pair of rear wheels and providing a scalable, compact and common suspension architecture for the skateboard chassis assembly.

7. The skateboard chassis assembly as set forth in claim 1, wherein said battery housing including a cover defining a seat attachment for allowing said cover to additional function as a floor of the electric vehicle for eliminating the floor from the body-in-white.

8. The skateboard chassis assembly as set forth in claim 1, wherein said central cross member of said frame defining a seat attachment for allowing said frame to additionally function as a floor of the electric vehicle for eliminating the floor from the body-in-white.

9. The skateboard chassis assembly as set forth in claim 1, wherein said pair of central longitudinal members including a shoulder for connecting said frame of the skateboard chassis assembly to a body-in-white.

10. The skateboard chassis assembly as set forth in claim 9, further comprising a seal extending between said shoulder and said body-in-white.

11. The skateboard chassis assembly as set forth in claim 9, further comprising at least one mechanical fastener extending between said shoulder and said body-in-white for connecting said frame of the skateboard chassis assembly to the body-in-white.

12. The skateboard chassis assembly as set forth in claim 9, further comprising at least one weld extending between said shoulder and said body-in-white for connecting said frame of the skateboard chassis assembly to the body-in-white.

13. The skateboard assembly as set forth in claim 2, further comprising a propulsion assembly supported by at least one of said front or rear portions of said frame.

14. The skateboard chassis assembly as set forth in claim 1, further comprising at least one battery module housed within said battery housing.

15. The skateboard chassis assembly as set forth in claim 14, further comprising a tray extending underneath said at least one battery module for supporting said at least one battery module within said battery housing.

16. The skateboard chassis assembly as set forth in claim 2, wherein said at least one pair of front longitudinal members includes a pair of front top longitudinal members and a pair of front bottom longitudinal members, and said at least one pair of rear longitudinal members includes a pair of rear top longitudinal members and a pair of rear bottom longitudinal members.

17. The skateboard assembly as set forth in claim 2, wherein a pivotable connection interconnects said front portion and said central portion of said frame.

18. The skateboard assembly as set forth in claim 13, wherein said propulsion assembly is comprised of an in-wheel motor.

19. The skateboard assembly as set forth in claim 7, wherein said cover is connected to a longitudinal tab on said pair of central longitudinal members on a first upper portion, and said cover includes a sidewall portion having a sidewall tab connected to said pair of central longitudinal members on a second lower portion.

20. The skateboard assembly as set forth in claim 19, further comprising a seal disposed between said longitudinal tab and said pair of central longitudinal members.
